(19) United States
(12) Patent Application Publication
(10) Pub. No.: US 2026/0228852 A1
(43) Pub. Date: Aug. 6, 2026

(54) ALGORITHMIC METHOD FOR SWAPPING IMAGE MEMORY ADDRESSES AND CIRCUIT SYSTEM

(71) Applicant: REALTEK SEMICONDUCTOR CORP., HSINCHU (TW)

(72) Inventors: Chung-Hui Chen, HSINCHU (TW); CHIA-CHOU TSAI, HSINCHU (TW); Hung-Ta Liu, HSINCHU (TW)

(21) Appl. No.: 19/531,686

(22) Filed: Feb. 6, 2026

(30) Foreign Application Priority Data
Feb. 6, 2025 (TW) 114104241

(51) Int. Cl. G06T 1/60

(52) U.S. Cl. CPC G06T 1/60

(57) ABSTRACT

An algorithmic method for swapping image memory addresses and a circuit system. The circuit system includes a processing circuit that executes a write client and a read client for operating image data memory address swapping and a memory. In the method, the circuit system receives image data from an image source, and the write client retrieves a selected update segment and writes the selected update segment into a virtual block. When the read client starts to read the virtual block, the selected update segment has already been written to the virtual block by the write client, and a previous virtual segment already records a previous frame image data. Thus, the previous frame image data and the selected update segment are combined in the virtual block while the write client is writing for generating a next frame image data that is configured to be read by the read client.

### CROSS-REFERENCE TO RELATED PATENT APPLICATION

This application claims the benefit of priority to Taiwan Patent Application No. 114104241, filed on February 6, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a technology of accessing image data, and more particularly to an image memory address swapping algorithm that performs a panel replay selected update process under a memory page flipping mechanism, and a circuit system.

### BACKGROUND OF THE DISCLOSURE

FIG. 1 is a schematic diagram depicting a conventional display system. In the diagram, a display system essentially includes an image-processing module 100 and a display 110. Main circuits of the image-processing module 100 includes a display driving circuit 101, an image input interface 103, an image output interface 105 and a memory 107. When the display system is in operation, the image-processing module 100 receives image data from an image source 120 via the image input interface 103. The image data is processed by the display driving circuit 101, buffered in the memory 107, and then outputted to the display 110 via the image output interface 105.

When an input frame rate and an output frame rate of the image-processing module 100 of the display system are different, the image-processing module 100 will store the image data processed by the display driving circuit 101 to the memory 107, by which a page flipping mechanism can be embodied so as to keep output images continuous and consistent after the image data is read from the buffer.

The technical concept behind the above-described frame rate control approach can be referred to in FIG. 2, which is a schematic diagram depicting operations of the memory of the present disclosure. The memory having a specific capacity of space of the display system is divided into multiple blocks. Each of the blocks stores an amount of data of one image frame. The schematic diagram shows three blocks 201, 202 and 203. Access process to the memory can be separated into a write client and a read client. When the memory is in operation, both the write client and the read client are required to select one of the blocks of the memory. While the write client and the read client will not continuously read and write the same block, each time after reading and writing the blocks, both the write client and the read client will try to access a next block. Taking the three blocks as an example, the write client and the read client can sequentially access the three blocks with different speeds, and the write client can directly write the image data received by the display system to a current selected block.

The write client and the read client will try to access a next block for processing a next image after completely processing one image data. For avoiding frame tear phenomenon, the frame rate control approach requires prohibiting the faster client from accessing the block that are accessed by the slower client and repeatedly processing the same image based on a speed relationship between the read client and the write client. In one aspect, after the faster read client or the write client completely processes the image data, when the slower write client or the read client accesses one of the blocks, the faster client remains at the current block for processing a next image. With faster write client as an example, the write client will overwrite a new image to the block that the write client remains accessing. With faster read client as an example, the read client will repeatedly read the block that is already read.

When the image-processing module of the display system outputs continuous frame images but only a part of the frame images is updated, the current images stored in the memory are combined with the selected update segment according to a conventional technology. Further reference is made to FIG. 3, which describes conventional operations of the memory for processing the selected update segment.

In FIG. 3, when a display driving circuit of the display system receives the current frame image data and buffers the image data to one of the memory blocks, e.g., a current frame image block 301 shown in the diagram, if only part of the subsequent images is updated, the display driving circuit only retrieves the updated segments 311 and 312 of the subsequent frame image block 301’. When the frame image block is outputted, the non-updated segment of the current frame image block 301 is combined with the updated segments 311 and 312 of the subsequent frame image block 301’ so as to form a combined block 303.

However, the conventional technology for processing images still encounters problems that additional read-write processes on the memory is required, which will inevitably increase a bandwidth of the display system used for the read-write process when the current frame image data in one of the memory blocks is copied to another block and combined with the selected update segment.

### SUMMARY OF THE DISCLOSURE

In response to the above-referenced technical inadequacies that the conventional technologies of frame rate control and image updating require additional write and read programs and bandwidth, provided in the present disclosure is an algorithmic method for swapping image memory addresses, and a circuit system that performs the algorithmic method for swapping image memory addresses. The circuit system includes a processing circuit and a memory. The processing circuit operates a write client and a read client for performing the algorithmic method for swapping image memory addresses.

In one aspect of the method, when the image data is received from an image source, the image source also sends a selected update segment. Next, the write client writes the image data to a virtual block, and then the read client reads the image data from the virtual block completely. Therefore, the image data completely read by the read client from the block can be kept to be latest and complete images, and the read client can start to read a next virtual block. After that, the selected update segment retrieved from the virtual block can be combined with the image data in a previous virtual block so as to generate a next frame image data.

Preferably, in the algorithmic method for swapping image memory addresses, the multiple virtual blocks are obtained by performing memory virtualization on the memory, each of the multiple virtual blocks is divided into multiple virtual segments, and each of the multiple virtual segments corresponds to one of multiple physical segments divided from any of one or more physical blocks, wherein a size of each of the virtual blocks or physical blocks is designed for writing one frame of the image data.

Further, when the read client reads the selected update segment and combines the selected update segment and image data of the previous virtual block, the non-selected update segments of the current virtual block and the previous virtual block are required to be swapped. A swapping process is performed on the different virtual blocks through a swapping function being configured for multiple mapping patterns and among the different mapping patterns.

Further, when the write client starts to frame-by-frame write the image data retrieved from the circuit system to the virtual block, it is checked whether the virtual segments of the virtual block to be written has the selected update segment used to update the images.

Still further, if the virtual block is checked to have the selected update segment having the images to be updated, swapping function of each of the segments is then checked to determine whether to perform a swapping process on a next virtual block.

Further, when the read client reads the image data of the virtual block, the swapping functions of the multiple virtual segments of the virtual block are one-by-one checked if an output of any of the swapping function is ‘1’ or ‘0’, by which it is determined whether each of the multiple virtual segments is required to be swapped.

When the output of the swapping function is ‘0’, no swapping process is performed on the current virtual segment to be read, and the read client continuously reads the virtual segment. Otherwise, when the output of the swapping function is ‘1’, the virtual segment of the virtual block to be read needs to be swapped.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram depicting operations of a memory of a conventional display system;

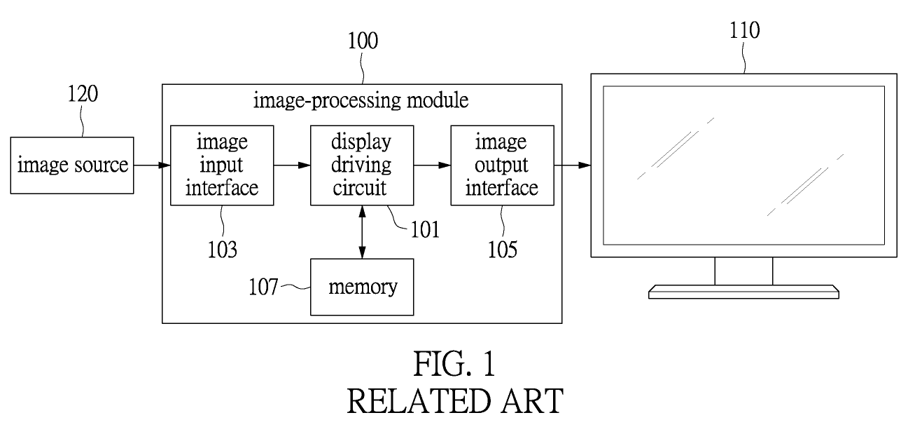

FIG. 2 is a schematic diagram depicting operations of the memory for frame rate control in the display system;

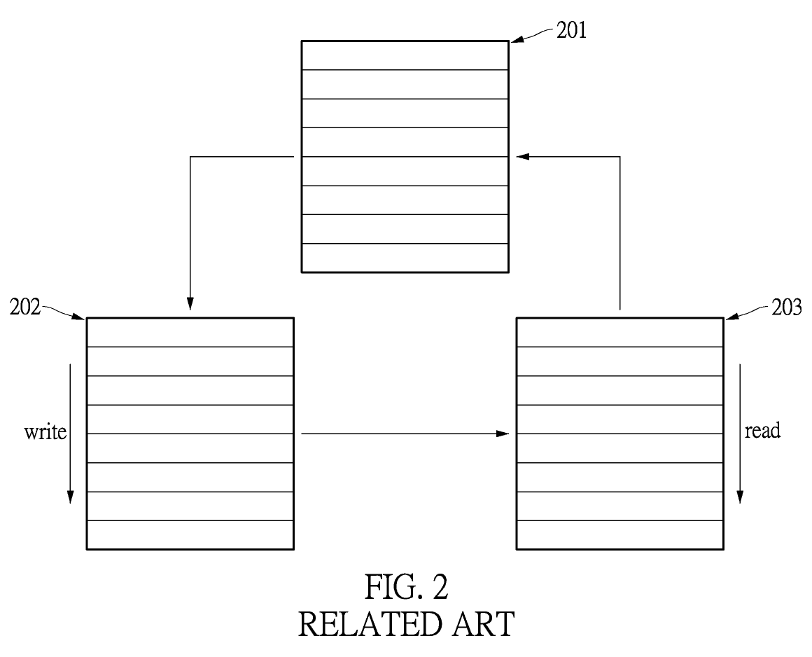

FIG. 3 is a schematic diagram depicting operations of the memory for processing partial updated images in the conventional technology;

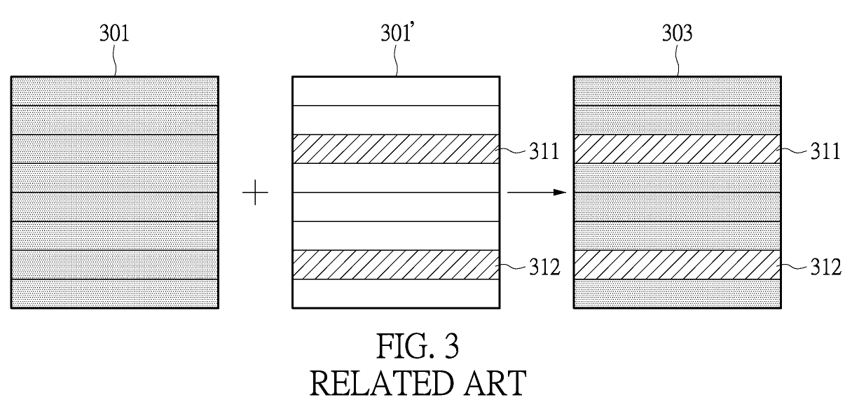

FIG. 4 is a schematic diagram depicting a framework of a circuit system operating an algorithmic method for swapping image memory addresses according to one embodiment of the present disclosure;

FIG. 5 is a schematic diagram depicting virtual segments of a virtual block mapped to physical segments of a physical block in one aspect of the present disclosure;

FIG. 6 is a schematic diagram depicting one of the patterns of mapping the virtual segments of the virtual block to the physical segments of the physical block in one aspect of the present disclosure;

FIG. 7 is a schematic diagram depicting multiple mapping patterns with three memory blocks as an example in one aspect of the present disclosure;

FIG. 8 is a flowchart illustrating a read client in the algorithmic method for swapping image memory addresses according to one embodiment of the present disclosure;

FIG. 9 is a flowchart illustrating a write client in the algorithmic method for swapping image memory addresses according to one embodiment of the present disclosure; and

FIG. 10A and FIG. 10B are schematic diagrams illustrating exemplary examples of the write client that access a first frame and a subsequent frame in one aspect of the present disclosure.

### DETAILED DESCRIPTION OF THE EXEMPLARY EMBODIMENTS

The present disclosure relates to an algorithmic method for swapping image memory addresses and a circuit system and is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to an algorithmic method for swapping image memory addresses and a circuit system. The circuit system is used to process image data and can be a system-on-chip (SoC) disposed in a display system. The received image data is buffered in a memory of the circuit system. The memory can be a double-data-rate (DDR) memory. The circuit system performs a read client and a write client on the image data in memory blocks, and outputs the image data to the display system for displaying contents.

According to certain embodiments of the algorithmic method for swapping image memory addresses, an address swap algorithm is used in the algorithmic method for performing a panel replay selected update procedure under a page flipping mechanism. The algorithmic method for swapping image memory addresses is suitable for the display system having two or more memory blocks. The embodiment of the present disclosure being described takes a memory being divided into three memory blocks as an example, but the method is not limited thereto.

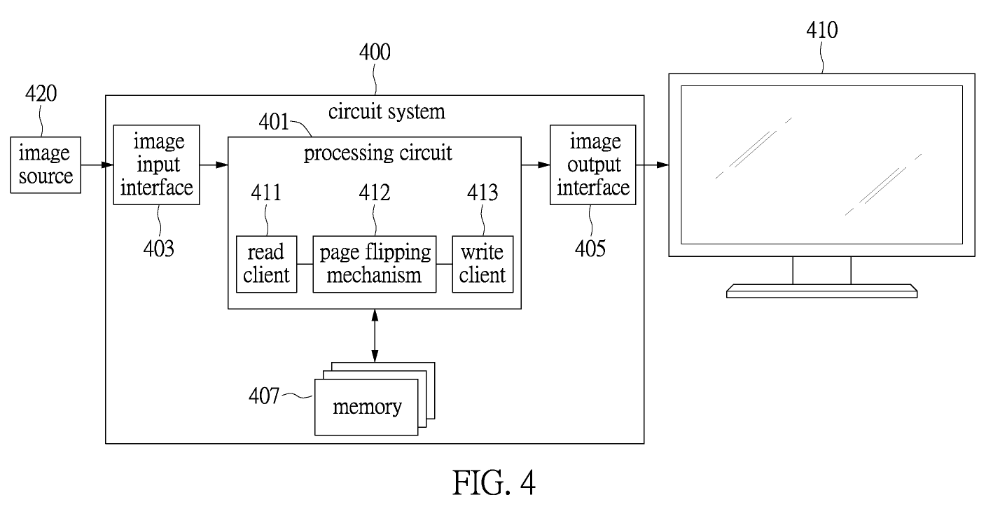

FIG. 4 is a schematic diagram illustrating a framework of the circuit system that operates the algorithmic method for swapping image memory addresses according to one embodiment of the present disclosure.

A circuit system 400 interconnected between an image source 420 and a display 410 is shown in FIG. 4. The circuit system 400 includes a processing circuit 401 used to process image data and control a read client 411 and a write client 413. Both the read client 411 and the write client 413 are configured to operate with a page flipping mechanism 412 that is operated in the circuit system 400. The circuit system 400 receives the image data from the image source 420 via an image input interface 403. After the image data is processed by the processing circuit 401, the image data can be outputted to the display 410 via an image output interface 405. The contents to be displayed by the display 410 are then generated. The image data is processed by a series of swapping and accessing operations performed on a memory 407.

The circuit system 400 performs the algorithmic method for swapping image memory addresses by the processing circuit 401. The algorithmic method is suitable for the display system having two or more memory blocks. The embodiments are disclosed with three memory blocks as an example, but the algorithmic method is not limited thereto.

In the algorithmic method for swapping image memory addresses performed in the circuit system 400, the processing circuit 401 performs the read client 411 and the write client 413 that are in compliance with the page flipping mechanism 412. Multiple virtual blocks used in the algorithmic method are provided by performing memory virtualization on the memory 407, and each of the multiple virtual blocks is divided into multiple virtual segments. Further, each of the multiple virtual segments corresponds to one of multiple physical segments divided from any of one or more physical blocks. A size of each of the virtual blocks or physical blocks is designed for writing one frame of the image data.

It should be noted that the selected update (SU) segment obtained from the image source 420 is transmitted along with segments of the image data. The write client 413 will not check the selected update segment in all of the segments of the image data at the beginning of data writing, but will check the selected update segment in a virtual segment when the write client 413 receives the segment of the image data from the image source 420. Thus, when the algorithmic method for swapping image memory addresses is in operation, the write client 413 obtains the selected update segment from the image data and writes the selected update segment to the virtual block and then ensures that the read client 411 can read the latest picture every time when the read client 411 completely reads the image data in the virtual block. If the read client 411 completely reads the image data in the virtual block and starts to read a next virtual block, the selected update segment obtained from the current virtual block can be combined with the image data in the previous virtual block so as to generate a latest image data for a next frame. The latest image data is then outputted to the display 410 for displaying pictures. Multiple virtual blocks can be obtained by performing memory virtualization on a memory 407 of the circuit system 400. The multiple virtual blocks include the virtual block, the previous virtual block and the next virtual block.

In an aspect of the present disclosure, the selected update segment read from the current virtual block is combined with the image data in the previous virtual block. Further, the non-selected update segment in the preceding and following virtual blocks are mapped and swapped. It should be noted that only the virtual segments in the virtual block are updated without accessing the physical memory when performing the algorithmic method for swapping image memory addresses.

The circuit system 400 performs the read client 411 and the write client 413 on the memory for solving the problem of frame tear that is caused when accessing the same memory block by different writing and reading speeds. The algorithmic method for swapping image memory addresses of the present disclosure applies a page flipping mechanism 412 in a double buffering manner to operate a panel replay selected update procedure, by which only the updated segment of a new picture is retrieved for combining with the unchanged segment of a previous picture.

It should be noted that, under the technical concept of the above-mentioned panel replay selected update procedure, the memory block is no longer copied in the algorithmic method for swapping image memory addresses when applying the page flipping mechanism, so that no additional bandwidth for accessing the memory is necessary. According to the following figures showing the processes represented by schematic diagrams of memory blocks, each of the memory blocks is designed to store a data capacity of one of frames of a received image data, and each of the memory blocks can be segmented into multiple segments (i.e., “N” segments), in which a segment “n” (i.e., nth segment) can be represented by “seg[n].”

When the algorithmic method for swapping image memory addresses is in operation, an aspect of a virtual block (vblock) that can be segmented into “N” virtual segments (vseg) is applied. Each of the virtual segments corresponds to a physical segment (pseg) that is segmented from a physical block that is the same as or different from the physical block corresponding to the virtual block. This means that each of the physical segments of the physical block is mapped to one of the virtual segments of the virtual block by swapping image memory addresses.

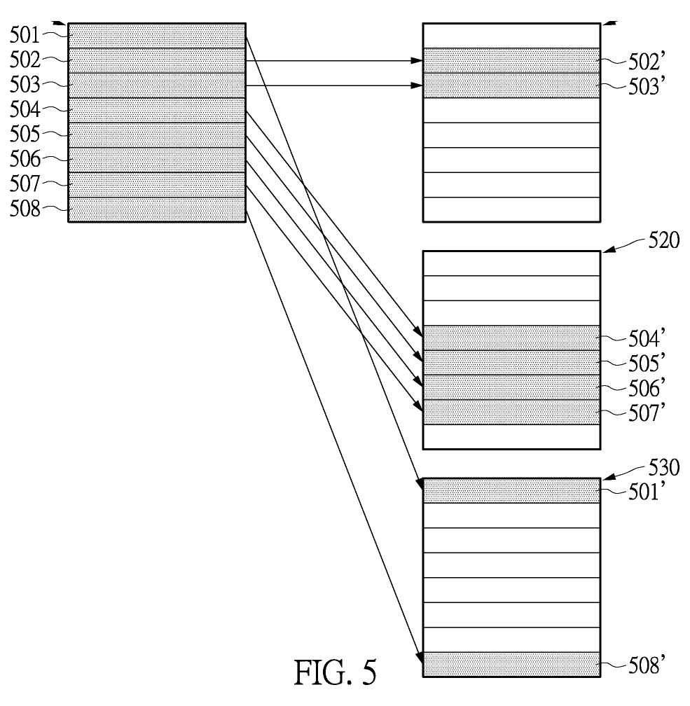

Reference is made to FIG. 5, which is a schematic diagram depicting multiple virtual segments of a virtual block being mapped to multiple physical segments in different physical blocks according to one embodiment of the present disclosure. The diagram is schematically used to show that each of the virtual segments (vseg[n]) can be configured to map to one of the physical segments of different physical blocks (pseg[n]).

A memory is configured to define a virtual block (vblock) 500 configured to perform swapping data. The virtual block 500 is schematically segmented into multiple virtual segments (vseg) 501, 502, 503, 504, 505, 506, 507 and 508. The memory physically includes multiple physical blocks (pblock) 510, 520 and 530, and each of the physical blocks can be segmented into multiple physical segments (pseg) with a consistent quantity.

In an exemplary example shown in the diagram, the virtual segments 501 and 508 of the virtual block 500 correspond to the physical segments 501’ and 508’ of the physical block 530, the virtual segments 502 and 503 of the virtual block 500 correspond to the physical segments 502’ and 503’ of the physical block 510, and the virtual segments 504, 505, 506 and 507 of the virtual block 500 correspond to the physical segments 504’, 505’, 506’ and 507’ of the physical block 520.

The parameters in the following figures are defined as follows, in which “n” denotes a number of a segment, “seg[n]” denotes a n^{th} segment, “vblock[r]” denotes a virtual block that a read client is reading from, “vblock[w]” denotes a virtual block that a write client is writing to, “SU” (selected update) denotes a portion of a new picture required to be updated, “[b]” denotes a block number, and “[n]” denotes a segment number. A swapping function “swap[b,b+1][n]” used in the algorithmic method for swapping image memory addresses records “1/0” to indicate whether a n^{th} virtual segment (vseg[b][n]) of a b^{th} virtual block and another n^{th} virtual segment (vseg[b+1][n]) of a (b+1)^{th} virtual block are required to be swapped. To describe mapping the virtual segment to the physical segment, a mapping segment (mapping[n]) indicates a corresponding relationship between the n^{th} virtual segments (vseg[n]) and the n^{th} physical segments (pseg[n]). Each of the virtual segments (vseg[n]) will correspond to one of the physical segments (pseg[n]). It should be noted that, in the algorithmic method for swapping image memory addresses, there is no overlapped segment when the physical segments (pseg) are used by the different virtual blocks (vblock) since the mapping segments (mapping[n]) are one-to-one corresponded.

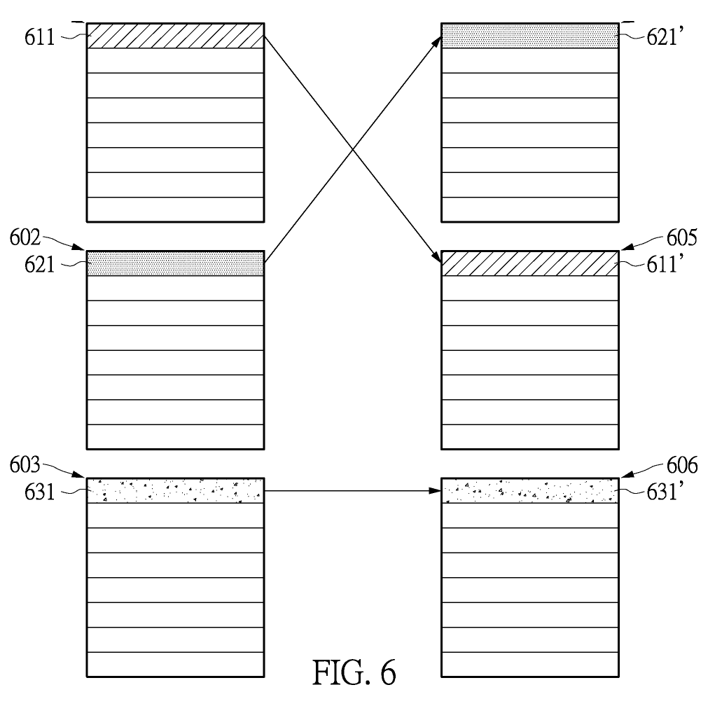

FIG. 6 is a schematic diagram illustrating that virtual segments of a virtual block respectively map to the physical segments of a physical block in one of the states according to one embodiment of the present disclosure. Each of the virtual segments “vseg[n]” maps to one of the physical segments “pseg[n]” of the physical block. The mapping state of the first virtual segment (seg[1]) of the virtual block herein is taken as an example.

As shown in the diagram, a virtual segment 611 of a virtual block 601 maps to a physical segment 611’ of a physical block 605, a virtual segment 621 of a virtual block 602 maps to a physical segment 621’ of a physical block 604, and a virtual segment 631 of a virtual block 603 maps to a physical segment 631’ of a physical block 606.

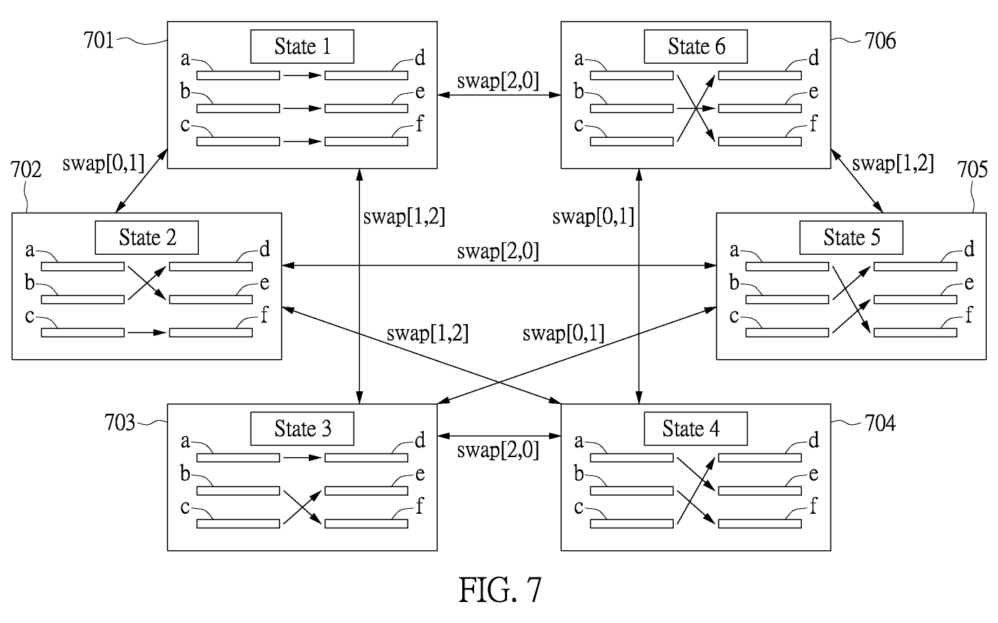

Reference is made to FIG. 7, which takes three memory segments as an example for describing multiple mapping patterns according to certain embodiments of the present disclosure. In the diagram, the multiple mapping patterns are described by three virtual segments being mapped to three physical segments.

The swapping function “swap[b,b+1][n]” uses a value of1 or 0 to record a scenario of whether the virtual block (vblock[b]) is swapped with a number “n” segment of another virtual block (vseg[b+1]). The figure exemplarily depicts one-to-one mapping relationships between the virtual segments a, b and c and the physical segments d, e and f in various patterns.

In the schematic diagram shown in FIG. 7, taking the n^{th} segment as an example, it is assumed that “a” denotes “vseg[0][n]”, “b” denotes “vseg[1][n]”, “c” denotes “vseg[2][n]”, “d” denotes “pseg[0][n]”, “e” denotes “pseg[1][n]”, and “f” denotes “pseg[2][n].” State 1 (701) indicates that the virtual segment “a” is mapped to the physical segment “d”, the virtual segment “b” is mapped to the physical segment “e”, and the virtual segment “c” is mapped to the physical segment “f”; State 2 (702) indicates that the virtual segment “a” is mapped to the physical segment “e”, the virtual segment “b” is mapped to the physical segment “d”, and the virtual segment “c” is mapped to the physical segment “f.” State 3 (703) indicates that the virtual segment “a” is mapped to the physical segment “d” the virtual segment “b” is mapped to the physical segment “f”, and the virtual segment “c” is mapped to the physical segment “e.” State 4 (704) indicates that the virtual segment “a” is mapped to the physical segment “e”, the virtual segment “b” is mapped to the physical segment “f”, and the virtual segment “c” is mapped to the physical segment “d.” State 5 (705) indicates that the virtual segment “a” is mapped to the physical segment “f”, the virtual segment “b” is mapped to the physical segment “d”, and the virtual segment “c” is mapped to the physical segment “e.” Further, State 6 (706) indicates that the virtual segment “a” is mapped to the physical segment “f”, the virtual segment “b” is mapped to the physical segment “e”, and the virtual segment “c” is mapped to the physical segment “d.”

Based on the mapping relationships between the virtual segments and the physical segments described in FIG. 7, in the algorithmic method for swapping image memory addresses, a mapping and swapping process is performed in between different virtual segments by setting a swapping function “swap[b,b+1][n]” between the various and different mapping patterns. The swapping function indicative of swapping a current virtual segment with another virtual segment can be stored to a specific recording medium.

According to an exemplary example shown in the figure, the State 1 (701) is swapped with the State 2 (702) that indicates the virtual segment “a” being swapped with the virtual segment “b.” The swapping function can be represented by “swap[0,1][n]”, which indicates that the function “vseg[0][n]” is swapped with the function “vseg[1][n].” The State 1 (701) is swapped with the State 3 (703) that indicates the virtual segment “b” being swapped with the virtual segment “c.” The swapping function can be represented by “swap[1,2][n]”, which indicates that the function “vseg[1][n]” is swapped with the function “vseg[2][n].” The State 1 (701) is swapped with the State 6 (706) that indicates the virtual segment “a” being swapped with the virtual segment “c.” The swapping function can be represented by “swap[2,0][n]”, which indicates that the function “vseg[2][n]” is swapped with the function “vseg[0][n].” The State 2 (702) is swapped with the State 4 (704) that indicates the virtual segment “b” being swapped with the virtual segment “c.” The swapping function can be represented by “swap[1,2][n].” The State 2 (702) is swapped with the State 5 (705) that indicates the virtual segment “a” being swapped with the virtual segment “c.” The swapping function can be represented by “swap[2,0][n].” The State 3 (703) is swapped with the State 4 (704) that indicates the virtual segment “a” being swapped with the virtual segment “c.” The swapping function can be represented by “swap[2,0][n].” The State 3 (703) is swapped with the State 5 (705) that indicates the virtual segment “a” being swapped with the virtual segment “b.” The swapping function can be represented by “swap[0,1][n].” The State 4 (704) is swapped with the State 6 (706) that indicates the virtual segment “b” being swapped with the virtual segment “a.” The swapping function can be represented by “swap[0,1][n].” The State 5 (705) is swapped with the State 6 (706) that indicates the virtual segment “c” being swapped with the virtual segment “b.” The swapping function can be represented by “swap[1,2][n].”

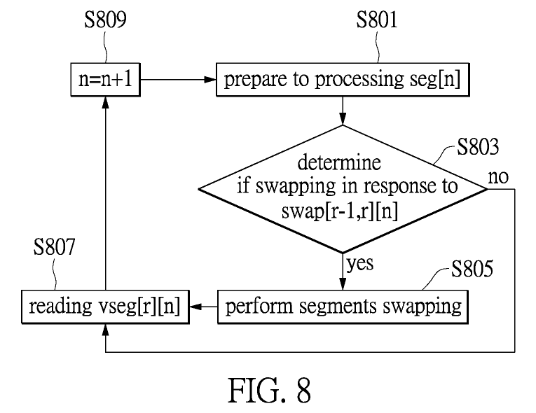

According to certain embodiments of the algorithmic method for swapping image memory addresses of the present disclosure, reference is made to FIG. 8, which is a flowchart illustrating operations of a read client in the algorithmic method for swapping image memory addresses based on the above-described swapping mechanism according to one embodiment of the present disclosure.

In the algorithmic method for swapping image memory addresses, the write client, in the beginning for preparing to process the n^{th} segment seg[n], writes the image data required to be updated (e.g., SU) to a current virtual block (vblock[]) (step S801). Next, after the read client reads the image data in the current virtual block, the read client starts to read a next virtual block by applying a swapping function shown in FIG. 7. In one of the embodiments, before the read client reads the image data in the virtual segments, the swapping function (swap[r-1,r][n]) of each of the virtual segments will be checked if an output of the swapping function is ‘1’ or ‘0’ (swap[r-1,r][n]) that is referred to for determining whether or not the swapping function is required to be performed (step S803). In other words, the swapping function is used to determine whether the virtual segments are required to be swapped.

In an aspect of the present disclosure, when the output of the swapping function “swap[r-1,r][n]” is ‘0’, it is indicated that the current virtual segment to be read will not be swapped (represented as “no”) and the read client continues to read the virtual segment vseg[r][n] (step S807); otherwise, when the output of the swapping function “swap[r-1,r][n]” is ‘1’, it is indicated that the virtual segment (number “n”) of the virtual block (number “r”) to be read will be swapped (represented as “yes”) (step S805) based on one of the states in the various mapping patterns shown in FIG. 7. As shown in FIG. 7, two of the virtual blocks are swapped for changing the mapping relationship there-between, by which the non-selected updated image data are swapped. The selected update segment can then be combined with the image frame in the previous virtual block. After performing the swapping, the current swapping function will be cleared and the read client is configured to read the virtual segment that is also going to step S807. Accordingly, it can ensure that the data read by the read client is the latest picture.

After that, the process goes on a next virtual segment (n=n+1) in step S809 and the above steps performed on the received image data are repeated again and then the process goes back to step S801 for performing the subsequent steps such as checking the swapping function and the read client for the next virtual segment (vseg[n], n=n+1) to be read. After repeating the above-mentioned steps for accomplishing swapping the non-selected updated segment, it is ensured that the image data to be read from the virtual block by the read client is the latest picture. Therefore, when the read client starts to read the next virtual block, the previous virtual block has already loaded a complete image frame that becomes the latest picture to be read at next time. It should be noted that it is unnecessary to use any extra physical memory in the above-described reading process.

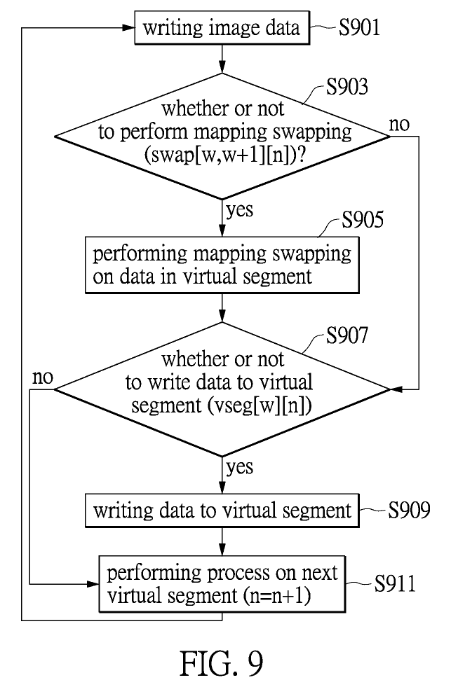

Reference is made to FIG. 9, which is a flowchart illustrating a writing process in the algorithmic method for swapping image memory addresses according to one embodiment of the present disclosure.

When the write client starts to write the image data obtained from the circuit system to a virtual segment (step S901), a swapping function will be checked for determining whether the current virtual block is mapped and swapped (swap[w,w+1][n]) with a next virtual block when the image data is written to the virtual segment (step S903), which is to determine whether the virtual segment is swapped with the next virtual block for avoiding the image data written to the virtual segment from overwriting the portion that is used to form a new picture. If the output of the swapping function is ‘0’, it is determined that no swapping is necessary (represented as “no”). Otherwise, if the output of the swapping function is ‘1’ (represented as “yes”), the image data currently to be written to the virtual segment (vseg[w][n]) is swapped to a virtual segment of a next virtual block (vseg[w+1][n]) (step S905). The swapping function will be cleared after the swapping process is performed. After that, the image data is written to the virtual segment.

In the step for determining whether to perform the swapping process between the virtual blocks, for a first frame image after the write client swaps the virtual blocks, the circuit system determines, no matter if the output of the swapping function is ‘1’ or ‘0’, whether to write the image data to a corresponding virtual segment (vseg[w][n]) according to the selected update segment transmitted from an image source (step S907). If it is determined that the image data being written to the virtual segment does not belong to the selected update segments, the outputs of the swapping functions (swap[w-1,w][n]) of the preceding and the following virtual blocks are set to ‘1’ and goes on to a next step for determining whether to perform the swapping process on a next virtual block (step S911). Otherwise, if the image data to be written by the write client belongs to the selected update segments, the output of the swapping function is set to ‘0’, and the image client writes the image data to the virtual segment (step S909), and goes on a next step for determining whether to perform the swapping process on a next virtual segment (n=n+1) (step S911).

It should be noted that both the read client and the write client in the algorithmic method for swapping image memory addresses use the virtual blocks instead of the physical blocks, operations of the read client and the write client are essentially based on a page flipping mechanism, and the above-described panel replay selected update procedure is performed through the swapping function for combining the selected update image data in the virtual blocks without any extra writing or reading process to be performed on the memory. The labeled segment in the swapping function (swap[b,b+1]) is referred to for swapping the mapped virtual blocks when the selected update image data are combined. After that, the image data in the virtual block (vblock[b+1]) will become a latest picture.

A supplementary description of the write client is as follows. An output of the swapping function (swap[w-1,w][n]) is set to ‘1’ if the image data written to the virtual segment (seg[n]) does not belong to the selected update segment, and it indicates that the non-selected updated segment in the virtual segments will be swapped. In particular, this operation can only be performed on a first frame after the write client swaps the virtual blocks.

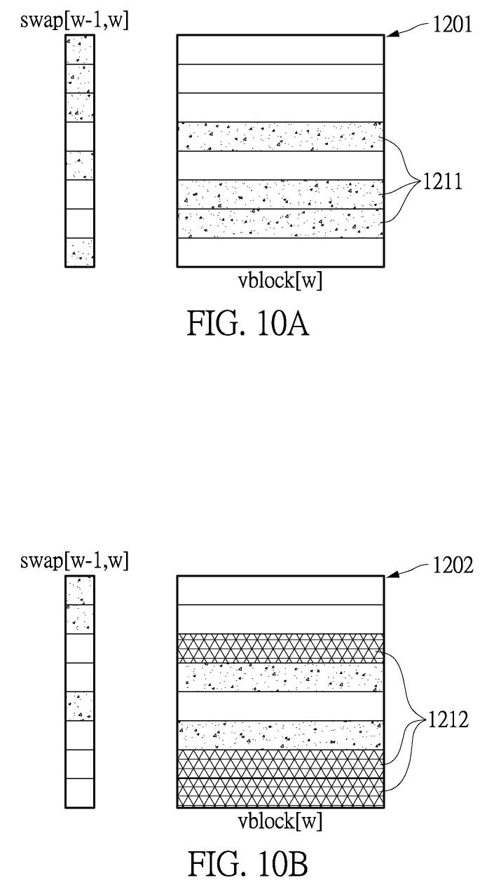

References are next made to FIG. 10A and FIG. 10B, which are schematic diagrams illustrating a write client processing a first frame and a subsequent frame while swapping the virtual blocks.

In FIG. 10A, when the write client repeatedly writes the image data to a same virtual block (vblock[w]) 1201, the selected update segments of the images will be overlapped, and the segments that are not overlapped to the virtual segment 1211 are the non-selected update segments, such as the segments not drawn with section lines in the virtual block 1201, which will be labeled in the swapping function swap[w-1,w].

In FIG. 10B, when the write client writes a second frame and the subsequent frames, the non-selected update segments may be the selected update segments in the previous images, such as the overlapped segments of the virtual segments 1212 and the virtual segments in FIG. 10A, which will not be labeled in the swapping function swap[w-1,w] for preventing misjudgment from regarding the segments required to be swapped.

The algorithmic method for swapping image memory addresses of the present disclosure can be adapted to several application scenarios as follows. In general, when the read client reads an entire virtual block (vblock[b]) and reads a latest picture, the read client will read another latest picture when reading an entire next virtual block (vblock[b+1]).

In a first application scenario, when the write client is faster than the read client, under the page flipping mechanism, the write client is prohibited to access the virtual block that the read client is reading; and, when the read client reads an entire virtual block (vblock[b]), the virtual block (vblock[b]) has a latest picture, and the read client goes on reading a next virtual block (vblock[b+1]). This reading process can be divided into the following two conditions.

Condition 1: the write client does not access the virtual block (vblock[b]); in the meantime, the read client determines whether or not to perform addresses swapping when operating the swapping function (swap[b,b+1][n]).

Condition 2: the write client accesses the virtual block (vblock[b]); in the meantime, the write client or the read client that is configured to access the virtual segment (vseg[n]) determines whether or not to perform swapping according an output of the swapping function (swap[b,b+1][n]). The write or the read client, which access the virtual segment (vseg[n]) later, will acknowledge that the swapping function (swap[b,b+1][n]) is cleared, so that a repetitive swapping can be avoided.

According to the above scenarios, it is acknowledged that, when the read client completely reads the virtual block (vblock[b+1]), all of the swapping steps are done and a latest picture can be read out from the virtual block (vblock[b+1]).

In a second application scenario, when the write client is slower than the read client, the read client starts to access a next virtual block (vblock[b+1]) after completely reading the virtual block (vblock[b]), and two conditions are as follows.

Condition 1: when the write client writes data to the virtual block (vblock[b]), according to the swapping function (swap[b,b+1][n]), the write client or the read client, which firstly accesses the virtual segment (vseg[n]), determines whether or not to perform address swapping, and the write client or the read client, which accesses the virtual segment (vseg[n]) later will acknowledge that the swapping function (swap[b,b+1][n]) should be cleared, so that a repetitive swapping can be avoided.

Condition 2: when the write client does not access the virtual block (vblock[b]), the swapping function (swap[b,b+1][n]) is configured to determine whether or not to perform address swapping through the read client. All of the swapping steps are done when the read client completely reads the virtual block (vblock[b+1]), and the read client can read a latest picture from the virtual block (vblock[b+1]).

In a third application scenario, when the read client completely reads the virtual block (vblock[b]) and the read client continues to access the virtual block (vblock[b]) when receiving a next picture, the picture read by the read client will be the same latest picture without being affected by the write client.

According to the memory page flipping mechanism, the read client is prohibited from accessing the virtual block that are accessed by the write client only if the write client is slower than the read client. Thus, it is possible that the read client remains in a state of accessing the current virtual block.

The swapping function (swap[b-1,b][n]) should be cleared if the read client still reads the virtual block (vblock[b]) when reading the previous frame. Further, since the write client is slower than the read client, the read client will not acknowledge any new label in the swapping function (swap[b-1,b][n]) even if the write client starts to access the virtual block that the reading client is reading. Accordingly, in this instance, no address swapping will be performed. Accordingly, the read client still reads the latest picture since the picture currently read by the read client is the same as the previous picture read by the read client.

In a fourth application scenario, when the write client completely writes the data to the virtual block (vblock[w]) and still continues to access this virtual block, the selected update segment to be written can be correctly overlapped to the virtual block (vblock[w]).

When the data that the write client writes to the virtual segments is the non-selected update segments, the write client labels the segments to the swapping function (swap[w-1,w][n]) only if it is the first frame that write client switches to virtual block (vblock[w]). However, no label will be set to the swapping function (swap[w-1,w][n]) if any subsequent write client or the read client keeps accessing the virtual block (vblock[w]), but the labeled segments in the swapping function will be cleared based on the newly-added selected update segments. Finally, any portion that is not cleared does not belong to any of the selected update segments and can be the virtual segments required to be swapped. On the other hand, if the data to be written to the virtual block belongs to the selected update segments, the data will be overlapped with the previously-written selected update segments, and the later written data will overwrite the previously-written data.

In a fifth application scenario, the algorithmic method of the present disclosure can deal with a condition that the picture is temporarily prohibited to be written to the virtual block. When the picture is prohibited to be written to the virtual block, it can be regarded that the write client writes the non-selected update segments to the virtual block.

In a sixth application scenario, in addition to using the virtual block to buffer the image data, the circuit system can provide an additional memory with capacity of “B*N + N*log2(B!)” bits, in which “B” denotes a quantity of memory blocks and “N” denotes a quantity of segments. Thus, “B” sets of the swapping function (swap[b,b+1][*]) and “N” swapping functions (swap[b,b+1][n]) of each of the sets are required. One of the swapping functions uses “1” bit and totally “B*N” bits. Further, when the mapping patterns shown in FIG. 7 include multiple factorials of “B” (B!) patterns. The memory requires log2(B!) bits and totally N*log2(B!) bits when “N” mapping patterns are provided.

In conclusion, according to the above embodiments relating to the algorithmic method for swapping image memory addresses and the circuit system of the present disclosure, the algorithmic method uses a write client to write selected update segment to a virtual block (vblock) for ensuring that the data to be read by a read client from the virtual block is always a latest picture. Further, under the page flipping mechanism, the algorithmic method can also ensure that no frame tear occurs when the selected update segment in an image is combined with a current image. Still further, when the read client enters a step for reading a next virtual block, the read client combines the selected update segment in the current virtual block with an image frame in a previous virtual block. Accordingly, in the combination process, non-selected update segments are exchanged by swapping a mapping relationship between the two virtual blocks without reading the memory. Therefore, no additional memory bandwidth is required to access the memory. Accordingly, only a few additional memory capacity is required when the memory blocks used to store image data is designed.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An algorithmic method for swapping image memory addresses, performed in a circuit system, comprising:
receiving image data from an image source, wherein the image source sends a selected update segment;
writing the image data to a virtual block by a write client;
after completely reading the virtual block, starting to read a next virtual block by a read client; and
combining the selected update segment retrieved from the virtual block and image data in a previous virtual block, so as to generate a next frame of image data.

2. The algorithmic method according to claim 1, wherein multiple virtual segments including the virtual block, the previous virtual block and the next virtual block are obtained by performing memory virtualization on a memory of the circuit system, wherein a size of each of the virtual blocks or physical blocks is designed for writing one frame of the image data.

3. The algorithmic method according to claim 1, wherein, when the read client reads the selected update segment and the selected update segment is combined with the image data in the previous virtual block, non-selected update segments of the virtual block and the previous virtual block are swapped.

4. The algorithmic method according to claim 3, wherein a swapping function is configured among multiple mapping patterns and different mapping patterns for performing swapping between the virtual blocks.

5. The algorithmic method according to claim 4, wherein multiple virtual segments including the virtual block, the previous virtual block and the next virtual block are obtained by performing memory virtualization on a memory of the circuit system, wherein a size of each of the virtual blocks or physical blocks is designed for writing one frame of the image data.

6. The algorithmic method according to claim 1, wherein, before the write client starts to write a current virtual segment, a swapping function of the current virtual segment is checked for determining whether the current virtual segment and a corresponding virtual segment of the next virtual block are to be swapped.

7. The algorithmic method according to claim 6, wherein multiple virtual segments including the virtual block, the previous virtual block and the next virtual block are obtained by performing memory virtualization on a memory of the circuit system, wherein a size of each of the virtual blocks or physical blocks is designed for writing one frame of the image data.

8. The algorithmic method according to claim 1, wherein, before the read client starts to read a current virtual segment, a swapping function of the current virtual segment is checked for determining whether the current segment and a corresponding virtual segment of the previous virtual block are to be swapped.

9. The algorithmic method according to claim 8, wherein, when an output of the swapping function is ‘0’, the virtual segment currently read by the read client is not to be swapped, and the read client continuously reads the virtual block; and, when the output of the swapping function is ‘1’, the virtual segment currently read by the read client is to be swapped.

10. The algorithmic method according to claim 9, wherein multiple virtual segments including the virtual block, the previous virtual block and the next virtual block are obtained by performing memory virtualization on a memory of the circuit system, and wherein a size of each of the virtual blocks or physical blocks is designed for writing one frame of the image data.

11. A circuit system, comprising:
a processing circuit and a memory, wherein the processing circuit performs a write client and a read client for operating an algorithmic method for swapping image memory addresses, comprising:
receiving image data from an image source, wherein the image source sends a selected update segment;
writing, by the write client, the image data to a virtual block;
after completely reading the virtual block, starting, by the read client, to read a next virtual block; and
combining the selected update segment retrieved from the virtual block and image data in a previous virtual block, so as to generate a next frame of image data.

12. The circuit system according to claim 11, wherein the multiple virtual blocks are obtained by performing memory virtualization on the memory, each of the multiple virtual blocks is divided into multiple virtual segments, and each of the multiple virtual segments corresponds to one of multiple physical segments divided from any of one or more physical blocks, wherein a size of each of the virtual blocks or physical blocks is designed for writing one frame of the image data.

13. The circuit system according to claim 11, wherein, when the read client reads the selected update segment and the selected update segment is combined with the image data in the previous virtual block, non-selected update segments of the virtual block and the previous virtual block are swapped.

14. The circuit system according to claim 13, wherein a swapping process is performed on the different virtual blocks through a swapping function being configured for multiple mapping patterns and among the different mapping patterns.

15. The circuit system according to claim 14, wherein the multiple virtual blocks are obtained by performing memory virtualization on the memory, each of the multiple virtual blocks is divided into multiple virtual segments, and each of the multiple virtual segments corresponds to one of multiple physical segments divided from any of one or more physical blocks, wherein a size of each of the virtual blocks or physical blocks is designed for writing one frame of the image data.

16. The circuit system according to claim 11, wherein, before the write client starts to write a current virtual segment, a swapping function of the current virtual segment is checked for determining whether the current virtual segment and a corresponding virtual segment of the next virtual block are to be swapped.

17. The circuit system according to claim 16, wherein the multiple virtual blocks are obtained by performing memory virtualization on the memory, each of the multiple virtual blocks is divided into multiple virtual segments, and each of the multiple virtual segments corresponds to one of multiple physical segments divided from any of one or more physical blocks, wherein a size of each of the virtual blocks or physical blocks is designed for writing one frame of the image data.

18. The circuit system according to claim 11, wherein, before the read client starts to read a current virtual segment, a swapping function of the current virtual segment is checked for determining whether the current segment and a corresponding virtual segment of the previous virtual block are to be swapped.

19. The circuit system according to claim 18, wherein, when an output of the swapping function is ‘0’, the virtual segment currently read by the read client is not to be swapped, and the read client continuously reads the virtual block; and, when the output of the swapping function is ‘1’, the virtual segment currently read by the read client is to be swapped.

20. The circuit system according to claim 19, wherein the multiple virtual blocks are obtained by performing memory virtualization on the memory, each of the multiple virtual blocks is divided into multiple virtual segments, and each of the multiple virtual segments corresponds to one of multiple physical segments divided from any of one or more physical blocks, and wherein a size of each of the virtual blocks or physical blocks is designed for writing one frame of the image data.
